(19) United States
(12) Patent Application Publication
(10) Pub. No.: US 2016/0070665 A1
(43) Pub. Date: Mar. 10, 2016

(54) PORTABLE ELECTRONIC DEVICE AND USER DATA ACCESS METHOD THEREFOR

(71) Applicant: HTC CORPORATION, Taoyuan City (TW)

(72) Inventor: Chao-Feng WAN, Taoyuan City (TW)

(73) Assignee: HTC CORPORATION, Taoyuan City (TW)

(21) Appl. No.: 14/480,065

(22) Filed: Sep. 8, 2014

(51) Int. Cl. G06F 13/28; G06F 12/02; G06F 9/44

(52) U.S. Cl. CPC G06F 13/28; G06F 9/4401; G06F 12/0246; G06F 2212/7201

(57) ABSTRACT

A portable electronic device with user data access method. The disclosed portable electronic device includes a first non-volatile memory, a central processing unit, an interface and a connector. The first non-volatile memory is configured to store first data. The central processing unit is powered with an operating voltage and is configured to run an operating system. The interface controller is electrically coupled to the first non-volatile memory. The connector is electrically coupled to the interface controller and configured to connect with a host device. When the central processing unit crashes or is not powered with the operating voltage, the interface controller is configured to read the first data stored in the first non-volatile memory and transmit the first data to the host device via the connector.

### BACKGROUND OF THE INVENTION

1. Field of the Invention

The present invention relates to portable electronic devices, and in particular, relates to user data access techniques.

2. Description of the Related Art

In a portable electronic device (such as a smartphone, a tablet PC and so on), the non-volatile memory stored with user data (e.g., videos, pictures, documents and so on) is generally bound to the central processing unit of the portable electronic device and is only accessible through the central processing unit. When the portable electronic device malfunctions, the central processing unit does not work and it is difficult to retrieve the user data in the non-volatile memory.

### BRIEF SUMMARY OF THE INVENTION

A portable electronic device and a user data access method therefor are disclosed.

A portable electronic device in accordance with an exemplary embodiment of the disclosure comprises a first non-volatile memory, a central processing unit, an interface controller and a connector. The first non-volatile memory is configured to store first data. The central processing unit is powered with an operating voltage and is configured to run an operating system. The interface controller is electrically coupled to the first non-volatile memory. The connector is electrically coupled to the interface controller and configured to connect with a host device. When the central processing unit crashes or is not powered with the operating voltage, the interface controller is configured to read the first data stored in the first non-volatile memory and transmit the first data to the host device via the connector.

In another exemplary embodiment of the disclosure, a user data access method is disclosed for a portable electronic device having a battery, a non-volatile memory, a central processing unit, a connector and an interface controller electrically coupled between non-volatile memory and the connector, The disclosed method comprises the following steps: powering the central processing unit by the battery; running an operating system by the central processing unit; and when the central processing unit crashes or is not powered by the battery, reading data, by the interface controller, from the non-volatile memory and transmitting the data, by the interface controller, to an external device via the connector.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram depicting a portable electronic device 100 in accordance with an exemplary embodiment of the disclosure;

FIG. 2 is a flowchart depicting a user data access method for a portable electronic device in accordance with an exemplary embodiment of the disclosure; and

FIG. 3 is a flowchart depicting a user data access method for a portable electronic device in accordance with another exemplary embodiment of the disclosure.

### DETAILED DESCRIPTION OF THE INVENTION

The following description shows several exemplary embodiments carrying out the invention. This description is made for the purpose of illustrating the general principles of the invention and should not be taken in a limiting sense. The scope of the invention is best determined by reference to the appended claims.

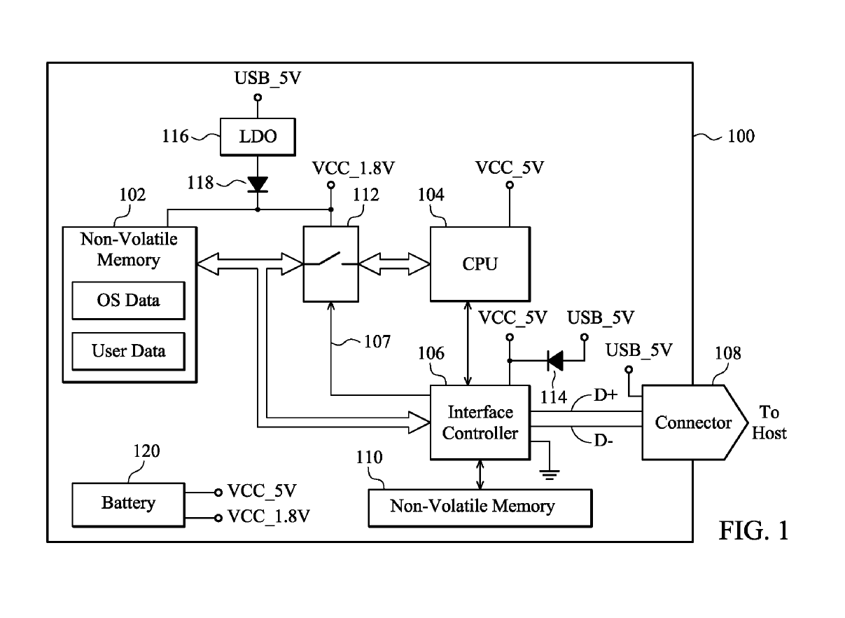

FIG. 1 is a block diagram depicting a portable electronic device 100 in accordance with an exemplary embodiment of the disclosure. The portable electronic device 100 in accordance with an exemplary embodiment of the disclosure comprises a non-volatile memory 102, a central processing unit (CPU) 104, an interface controller 106 (e.g. a universal serial bus controller), a connector 108 (e.g. a universal serial bus connector), a non-volatile memory 110 (e.g. an electrically erasable programmable read-only memory), a switch 112 (e.g. a bus switch), diodes 114 and 116, a low-dropout regulator 118 and a battery 120.

The non-volatile memory 102 is stored with program codes of an operating system, which is used for execution of the operating system, as well as user data (e.g., videos, pictures, documents and so on). The non-volatile memory 102 is accessed by the central processing unit 104 or the interface controller 106.

In this embodiment, the interface controller 106 may be booted up independently from the central processing unit 104. Thus, when the central processing unit 104 crashes or is not powered with the operating voltage VCC_{—}5V, the interface controller 106 is still workable to access the user data from the non-volatile memory 102. The connector 108 is controlled by the interface controller 106 and operative to connect the portable electronic device 100 to a host. When the central processing unit 104 crashes or is not powered with the operating voltage VCC_{—}5V, the non-volatile memory 102 is accessed by the host via the connector 108 and the interface controller 106. Thus, the non-volatile memory 102 is still accessible via the interface controller 106 although the central processing unit 104 crashes or is not powered with the operating voltage VCC_{—}5V. The conditions that make central processing unit 104 not been powered with the operating voltage VCC_{—}5V may include that the portable electronic device 100 is not turned on or that the battery 120 fails to supply the operating voltage VCC_{—}5V to power the central processing unit 104 even when the portable electronic device 100 is turned on.

In the exemplary embodiment shown in FIG. 1, the non-volatile memory 110 is stored with codes to be accessed and executed by the interface controller 106 for booting up the interface controller 106 independently from the central processing unit 104. In an alternative embodiment, the interface controller 106 may include a storage element for storing the boot-up codes for booting up the interface controller itself 106.

In the exemplary embodiment shown in FIG. 1, the switch 112 is electrically connected between the non-volatile memory 102 and the central processing unit 104. The switch 112 may be closed in default for communication between the central processing unit 104 and the non-volatile memory 102. When the central processing unit 104 crashes or is not powered with the operating voltage VCC_{—}5V, the interface controller 106 opens the switch 112 to electrically disconnect the crashing or non-powered central processing unit 104 from the non-volatile memory 102. In this manner, the communication bus to the non-volatile memory 102 is isolated from the crashing or non-powered central processing unit 104. The switch 112 is optional and may be replaced by any component capable of breaking a communication path between the central processing unit 104 and the non-volatile memory 102. In an exemplary embodiment, when the central processing unit 104 crashes or is not powered with the operating voltage VCC_{—}5V, the interface controller 106 will send a control signal 107 to the switch 112, and the switch 112 turns to be open according to the control signal 107.

Further, the interface controller 106 may be isolated from the non-volatile memory 102 by high impedance when the connector 108 is floating. In this embodiment, the connector 108 is floating means that the connector 108 is not connected with any external host device, e.g. a computer. In this manner, the communication between the central processing unit 104 and the non-volatile memory 102 is not interfered by the interface controller 106. For example, the bus interface between the interface controller 106 and the non-volatile memory 102 may be asserted to high impedance when the connector 108 is floating.

When the central processing unit 104 crashes, it may not respond to the interface controller 106 or any components connected thereto. In an exemplary embodiment, the switch 112 turns to be open according to the control signal 107 when the central processing unit 104 does not respond to the interface controller 106 while crashing and the connector 108 is connected with a host device (e.g. the connection could be detected by the interface controller 106). In the meantime, the bus interface between the interface controller 106 and the non-volatile memory 102 may be asserted to low impedance so that the interface controller 106 can access the user data of the non-volatile memory 102 according to commands from the connected host device and thereby the portable electronic device 100 is operated as a portable storage device (e.g. a universal serial bus disc). User data access is easily performed.

In the exemplary embodiment shown in FIG. 1, the battery 120 is provided to power the components in the portable electronic device 100. In one embodiment, the battery 120 may power the components via a PMIC (power management IC). For example, the battery 120 may supply the operating voltage to the CPU 104 via the PMIC electrically connected between the battery 120 and the CPU 104. In this embodiment, the battery 120 directly provides or indirectly provides via the PMIC a high voltage VCC_{—}5V and a low voltage VCC_{—}1.8V to power different components in the portable electronic device 100. When the battery 120 fails, the central processing unit 104 does not work, but the non-volatile memory 102, the interface controller 106, the non-volatile memory 110 and the switch 112 may be powered by an external power source, e.g. a voltage USB_{—}5V, which is provided by the host device through the connector 108, e.g. a USB connector.

In an exemplary embodiment, the switch 112 turns to be open according to the control signal 107 when the battery 120 fails and the connector 108 is connected with a host device. In the meantime, the bus interface between the interface controller 106 and the non-volatile memory 102 may be asserted to low impedance so that the interface controller 106 can access the user data of the non-volatile memory 102 according to commands from the connected host device and thereby the portable electronic device 100 is operated as a portable storage device. User data access is easily performed.

As shown in FIG. 1, the diode 114 is provided to couple the external power source USB_{—}5V to a power terminal, which is configured to receive the operating voltage VCC_{—}5V in default, of the interface controller 106. The low-dropout regulator 116 and the diode 118 are connected in series to couple the external power source USB_{—}5V to the power terminals, which are configured to receive the voltage VCC_{—}1.8V in default, of the non-volatile memory 102 and the bus switch 112. In other exemplary embodiments, an additional set of a low-dropout regulator and diode is provided, and thereby the non-volatile memory 102 and the switch 112 are powered by the external power source USB_{—}5V via separate paths.

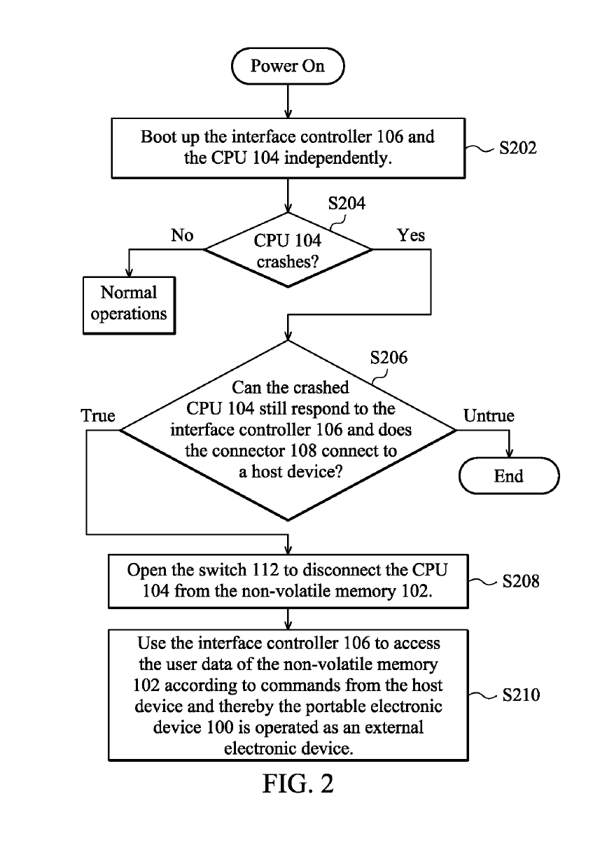

FIG. 2 is a flowchart depicting a user data access method for a portable electronic device in accordance with an exemplary embodiment of the disclosure, which is discussed with respect to the structure shown in FIG. 1. In this example, the battery 120 still provides power normally. When the portable electronic device 100 is powered on, the central processing unit 104 and the interface controller 106 are booted up independently in step S202. At the meantime, the switch 112 is kept in the default state (“closed”) and the central processing unit 104 accesses the non-volatile memory 102 for executing codes of software applications stored in the non-volatile memory 102. When it is detected in step S204 that the central processing unit 104 crashes, step S206 is performed to determine whether the crashed central processing unit 104 can still respond to the interface controller 106 and whether the connector 108 connects to a host device. When the central processing unit 104 does not respond to the interface controller 106 and a plug-in action of a host device at the connector 108 is detected, step S208 is performed to open the switch 112 to disconnect the central processing unit 104 from the non-volatile memory 102 according to the control signal 107 outputted by the interface controller 106. Accordingly, the crashing central processing unit 104 is isolated from the non-volatile memory 102. In the meantime, the bus interface between the interface controller 106 and the non-volatile memory 102 is asserted to low impedance so that, in step S210, the interface controller 106 can access the user data of the non-volatile memory 102 according to commands from the host device and thereby the portable electronic device 100 is operated as an external storage device. User data access is easily performed.

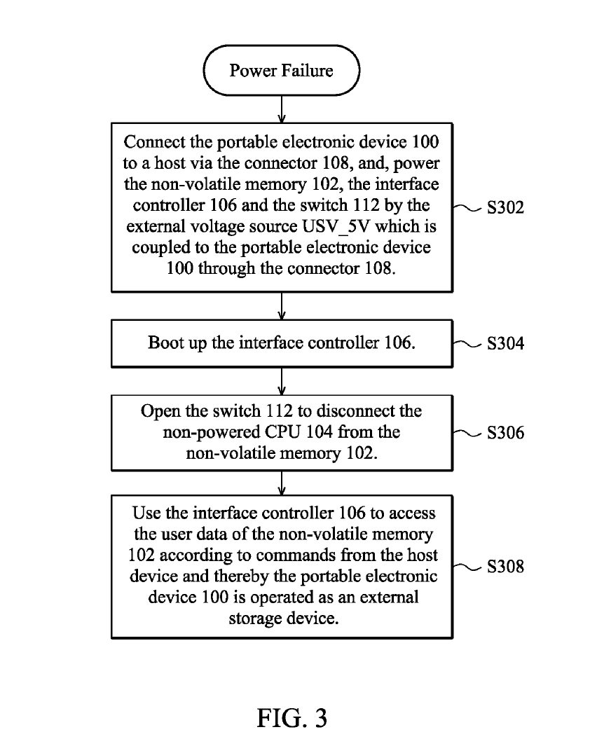

FIG. 3 is a flowchart depicting a user data access method for a portable electronic device in accordance with another exemplary embodiment of the disclosure, which is discussed with respect to the structure shown in FIG. 1. In this example, the battery 120 fails and the portable electronic device 100 cannot be powered on. In step S302, the portable electronic device 100 is connected to a host device via the connector 108, and, the non-volatile memory 102, the interface controller 106 and the switch 112 are powered by the external power source USB_{—}5V, which is outputted by the host device to the portable electronic device 100 through the connector 108. In step S304, the interface controller 106 is booted up, without any effort from the non-powered central processing unit 104. In step S306, the switch 112 is opened to disconnect the non-powered central processing unit 104 from the non-volatile memory 102 according to the control signal 107 outputted by the interface controller 106. Accordingly, the non-powered central processing unit 104 is isolated from the non-volatile memory 102. In the meantime, the bus interface between the interface controller 106 and the non-volatile memory 102 is asserted to low impedance so that, in step S308, the interface controller 106 can access the user data of the non-volatile memory 102 according to commands from the host device and thereby the portable electronic device 100 is operated as an external storage device. User data access is easily performed.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device, comprising:
a first non-volatile memory configured to store first data;
a central processing unit powered with an operating voltage and configured to run an operating system;
an interface controller electrically coupled to the first non-volatile memory; and
a connector electrically coupled to the interface controller and configured to connect with a host device,
wherein when the central processing unit crashes or is not powered with the operating voltage, the interface controller is configured to read the first data stored in the first non-volatile memory and transmit the first data to the host device via the connector.

2. The portable electronic device as claimed in claim 1, wherein when the central processing unit crashes or is not powered with the operating voltage, the interface controller is further configured to receive second data from the host device via the connector and write the second data to the first non-volatile memory.

3. The portable electronic device as claimed in claim 1, wherein the interface controller is a universal serial bus (USB) controller and the connector is an USB connector.

4. The portable electronic device as claimed in claim 1, wherein the interface controller is booted up independently from the central processing unit.

5. The portable electronic device as claimed in claim 4, further comprising:
a second non-volatile memory electrically connected to the interface controller and configured to store codes to be executed by the interface controller, wherein the interface controller is booted up with the codes.

6. The portable electronic device as claimed in claim 1, wherein:
the interface controller is isolated from the first non-volatile memory by high impedance when the connector is floating.

7. The portable electronic device as claimed in claim 1, further comprising:
a switch connected between the central processing unit and the first non-volatile memory and configured to be closed in default for communication between the central processing unit and the first non-volatile memory,
wherein when the central processing unit crashes or is not powered with the operating voltage, the switch turns to be open and electrically disconnects the central processing unit from the first non-volatile memory.

8. The portable electronic device as claimed in claim 7, wherein:
when the central processing unit does not respond to the interface controller while crashing and the connector connects with the host device, the switch turns to be open and disconnects the central processing unit from the first non-volatile memory.

9. The portable electronic device as claimed in claim 7, wherein:
the first non-volatile memory is further configured to store program codes of the operating system.

10. The portable electronic device as claimed in claim 7, further comprising a battery for supplying the operating voltage, wherein when the central processing unit is not powered with the operating voltage and the connector connects with the host device, the non-volatile memory, the interface controller and the switch are powered with an external voltage provided by the host device through the connector.

11. The portable electronic device as claimed in claim 10, wherein:
when the central processing unit is not powered with the operating voltage and the connector connects with the host device, the switch turns to be open and disconnects the central processing unit from the first non-volatile memory.

12. The portable electronic device as claimed in claim 10, further comprising:
a first diode configured to couple the external voltage to the interface controller when the central processing unit is not powered with the operating voltage and the connector connects with the host device.

13. The portable electronic device as claimed in claim 7, wherein:
a second diode and a low-dropout regulator connected in series and configured to couple the external voltage to the first non-volatile memory.

14. A user data access method for a portable electronic device having a battery, a non-volatile memory, a central processing unit, a connector and an interface controller electrically coupled between non-volatile memory and the connector, the method comprising:
powering the central processing unit by the battery;
running an operating system by the central processing unit; and
when the central processing unit crashes or is not powered by the battery, reading data, by the interface controller, from the non-volatile memory and transmitting the data, by the interface controller, to an external device via the connector.

15. The user data access method as claimed in claim 14, wherein the powering step further comprising:
booting up the interface controller and the central processing unit independently.

16. The user data access method as claimed in claim 14, further comprising:
isolating the interface controller from the non-volatile memory by high impedance when the connector is floating.

17. The user data access method as claimed in claim 14, further comprising:
when the central processing unit crashes or is not powered by the battery, electrically disconnecting the central processing unit from the non-volatile memory.

18. The user data access method as claimed in claim 14, further comprising:
when the central processing unit does not respond to the interface controller while crashing and the connector connects with the external device, electrically disconnecting the central processing unit from the non-volatile memory.

19. The user data access method as claimed in claim 14, further comprising:
when the central processing unit is not powered by the battery and the connector connects with the external device, powering the non-volatile memory and the interface controller with an external voltage provided by the external device through the connector; and
booting up the interface controller.

20. The user data access method as claimed in claim 19, further comprising:
when the central processing unit is not powered by the battery and the connector connects with the external device, electrically disconnecting the central processing unit from the non-volatile memory.
